(19) United States
(12) Patent Application Publication
(10) Pub. No.: US 2013/0301918 A1
(43) Pub. Date: Nov. 14, 2013

(54) SYSTEM, PLATFORM, APPLICATION AND METHOD FOR AUTOMATED VIDEO FOREGROUND AND/OR BACKGROUND REPLACEMENT

(71) Applicant: Shy FRENKEL, YAAD (IS)

(72) Inventor: Shy FRENKEL, YAAD (IS)

(73) Assignee: VIDEOSTIR LTD., Yaad (IS)

(21) Appl. No.: 13/888,672

(22) Filed: May 7, 2013

Related U.S. Application Data
(60) Provisional application No. 61/644,031, filed on May 8, 2012.

(51) Int. Cl. G06T 7/00

(52) U.S. Cl. CPC G06T 7/0081
USPC 382/180

(57) ABSTRACT

A system, platform, application and method are provided to enable automated video and image background segmentation and replacement, wherein the platform includes a video background segmentation and replacement module including a segmentation and replacement engine and engine processing script(s); a program interface for allowing data provision to the segmentation and replacement module; and a remote device providing remote user access to the server, wherein the remote device runs code to enable automatic placement of a frame(s) foreground with a replaced background on a viewing platform.

### CROSS REFERENCE TO RELATED APPLICATIONS

This application claims the benefit of U.S. Provisional Patent Application 61/644,031, filed 8 May, 2012, entitled “METHOD OF USING AN AUTOMATED VIDEO AND IMAGE BACKGROUND DETECTION AND REPLACEMENT SYSTEM”, which is incorporated in its entirety herein by reference.

### FIELD OF THE INVENTION

The present invention relates to methods and tools useful in video processing, and more specifically, embodiments of the present invention relate to platforms, methods and applications that provide enhanced video segmentation.

### BACKGROUND OF THE INVENTION

Segmenting videos and replacing their background methods have long been known and widely used. The common usages mostly rely on videos that were filmed in a “green/blue screen studio” (A.K.A chroma key) and required a dedicated manual editing software that was based on manual user inputs such as marking the foreground/background areas in the video and manually choosing the requested segmentation function that is required until requested result was achieved.

Currently known segmentation methods have resulted in many video related usages. For example, private and commercial usages of videos/images that hold replaced/transparent background can be found in many of today's media channels such as the internet/smartphones/TV/movies and more. Nevertheless, simplified segmentation using varied video formats or types opens more possible usages and flexibility in choosing new and creative ways of using these segmented videos.

Though such segmentation methods have achieved considerable popularity and commercial success, there is a continuing need for simplifying the process, and for making such segmentation available, easy and fast for executing on any video, even if not filmed in a “green/blue screen studio”, but rather using a standard colored or natural backdrop.

Currently, users without any technological knowledge that want to have their video/image background replaced with another video/image as background or replaced with a transparent background commonly require a video that was created using a green/blue screen as background, a video/image editor that use a video/image editing manual software, and/or an external service provider that may offer to provide full or partial service of creating and editing a video/image for a user. These alternatives are problematic in the sense that they take time and money from the users and in some cases take away the choice to specifically define the video/image content or even appear in it by themselves.

It would be highly advantageous to provide a fast and easy process that allows any user to have better control of the video/image content, substantially without technological knowledge, from substantially any video clip or image.

### SUMMARY OF THE INVENTION

A platform, application and method are provided to enable automated video and image foreground and/or background segmentation and replacement, wherein the platform includes a video foreground and/or background replacement module including a segmentation and replacement engine and engine processing scripts; a program interface for allowing data provision to the segmentation and replacement module; and an end user device providing remote user access to the server, wherein the remote device runs code to enable automatic placement of a selected frame(s) foreground with a selected frame background on the device.

In some embodiments the code to run on a device is a video segmentation and replacement application.

In further embodiments the segmentation and replacement module runs on a server.

In further embodiments the segmentation and replacement module runs on a data cloud.

In further embodiments the segmentation and replacement module runs on a remote user device.

In further embodiments the selected frame foreground is configured with a selected replacement frame background.

In further embodiments the selected frame background is configured with a selected replacement frame foreground.

In further embodiments the background is a transparent background.

In further embodiments the segmentation and replacement engine and engine processing script(s) are adapted to enable background segmentation of a frame(s) captured against a standard backdrop.

In further embodiments the frame is one of a stills image, video frame and animation frame.

In further embodiments the viewing platform may include one or more platforms selected from websites, PCs, televisions, smartphones, tablets, multimedia players, communication devices and game consoles.

In accordance with some embodiments of the present invention, a method is provided for enabling remote user video background replacement, including running video segmentation code to automatically segregate a video frame background and foreground; allowing a remote user to choose an existing background input artifact from a predefined list of templates; and running video background replacement code to allow the user to run a selected multimedia output artifact on top of a multimedia viewing application, with the selected background input artifact, by generating an integration code that causes the output artifact to appear on top of a selected multimedia program or channel.

In further embodiments the frame background and frame foreground may be interchanged, using the above described method.

In further embodiments the method allows the user to run the multimedia output artifacts on top of a multimedia program, by generating a link and embedding code to cause the selected multimedia output artifacts to actually run on a selected multimedia program.

In further embodiments the video segmentation code acts to segregate a video frame background and foreground by comparing each video input frame to a background reference frame, by a segmentation engine; collecting a set of possible reference frames, by the segmentation engine that represent the assumed possible background; selecting an optimal reference background frame to work with based on defined parameters and sensitivity levels; comparing the reference frame to the input frame in order to better define which pixel in the frame should be the foreground and which pixel should be the background.

In further embodiments the existing background input artifact is acquired from a video filmed with a standard colored backdrop.

In accordance with some embodiments of the present invention, a platform is provided for enabling video background replacement, including a centralized server running a segmentation and replacement engine and utility scripts, such as engine output processing scripts; a video hosting server; a multimedia viewing platform or device on which a video frame with a replacement video background is to be run; and a user operating an end user device, wherein the utility scripts are designed to segment and replace a remote user video background on a selected media channel.

In further embodiments the frame background and frame foreground may be interchanged, using the above described platform.

In further embodiments the described media channel may include one or more platforms selected from websites, PCs, televisions, smartphones, tablets, multimedia players, and game consoles.

In further embodiments, the platform includes an application for enabling video background replacement on an end user device, the application including engine output processing scripts to provide enhancing foreground and/or background processing to enable selected video frame foreground(s) with selected video frame background(s) to be run on an end user device.

In accordance with some embodiments of the present invention, an application is provided for enabling video background replacement, including a segmentation and replacement engine and engine output processing scripts; a video hosting module; and a user operating an end user device with a multimedia viewing capacity on which a video frame(s) with a replacement video background is to be run.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a flow chart illustrating examples of input and output examples by a Segmentation engine, according to some embodiments;

FIG. 2 is a flow chart illustrating examples of input and output flow by a Segmentation engine using a centralized model, according to some embodiments;

FIG. 3 is a flow chart illustrating examples of input and output flow by a Segmentation engine using a centralized model with video hosting, according to some embodiments;

FIG. 4 is a flow chart illustrating examples of input and output flow by a Segmentation engine using a smartphone application, according to some embodiments;

FIG. 5 is a flow chart illustrating examples of input and output flow by a Segmentation engine using software downloaded to users PC/server, according to some embodiments;

FIG. 6 is a flow chart illustrating examples of input and output flow by a Segmentation engine using a software plugin/module downloaded to users PC/server with a centralized server, according to some embodiments;

FIG. 7 is a flow chart illustrating examples of input and output flow by a Segmentation engine using a smartphone application and a centralized server, according to some embodiments;

FIG. 8 is a flow chart illustrating examples of input and output flow by a Segmentation engine using an interface module connected to a centralized server as part of 3rd party software, according to some embodiments;

FIG. 9 is a flow chart illustrating examples of input and output flow by a Segmentation engine using a software module as part of 3rd party software, according to some embodiments;

FIG. 10 is an example of a screenshot showing a Video clip with its background image replaced, according to some embodiments;

FIG. 11 is an example of a screenshot showing a Video clip with a transparent background on top of a website, according to some embodiments; and

FIG. 12 is a flow chart describing segmentation guidelines, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

As used herein, the term “video” may refer to any relevant digital visual sensory data or information, including utilizing captured still scenes, moving scenes, animated scenes etc., from multimedia, streaming media, interactive or still images etc. Accordingly, the term “video background” may include image background, and may include video or image data from videos, films, pictures, clips, animations, stills, streaming content etc.

In some examples: the format of Video files used may include: avi, mov, mp4, 3gp, wmv, fly, mpeg or other formats. Video files may hold videos from Huffyuv, H264, MPEG-4 or other codecs'. Images may be integrated from JPEG, PNG, GIF, BMP, TIFF or other formats. Audio files may be separated from videos, for example, into mp3, wav or other formats. Videos and images may be from substantially any resolution and substantially any width/height ratio (for example 3:4, 9:16 aspect ratio). Audio files may hold substantially any content (e.g., recording, music, etc.) and be of substantially any existing type (e.g., 2 channels, different bps, sample rates etc.). Streams of video, images or audio may be received substantially in real time from a recording device such as a video camera, web camera, smartphone/tablet camera, stills camera, or any voice recording device.

Embodiments of the present invention provide a platform, application and/or method for automatically segmenting a video and/or image into a foreground and a background. In an additional aspect, the video or image's initial background, which may be a standard colored or natural backdrop, or a specialized “green/blue screen studio” can be replaced with either a transparent background or with a selected external background image or background video, thereby enabling substantially automated video/image segmentation and background replacement that simplifies the flow of actions that video holders need to take in order to make personal or commercial use of their segmented artifacts on a variety of multimedia viewing platforms or devices.

In an additional aspect, the video or image's initial foreground can be replaced with a selected foreground image or video, thereby enabling substantially automated video/image segmentation and foreground replacement that simplifies the flow of actions that video holders need to take in order to make personal or commercial use of their segmented artifacts on a variety of multimedia viewing platforms.

According to some embodiments, the video segmentation and replacement platform includes a segmentation and replacement engine (herein referred to as “segmentation engine”) running a processing algorithm for converting videos and images that were not necessarily made with a green/blue screen background, into new video/images artifacts, optionally with a replaced or transparent background, substantially without using video/image editing software; a program interface, such as an API, for allowing data provision to said segmentation and replacement module; and a remote device providing remote user access to the engine, wherein the remote device runs a video segmentation application to enable automatic placement of a frame foreground with a replaced background on a viewing platform, such as a multimedia viewer device. The video/image segmentation and replacement engine and/or processing scrips may further include Segmentation engine input artifacts; Segmentation engine logic and specifications; Segmentation engine output artifacts; Additional software elements including utility scripts; System environment and additional system artifacts; and Output artifacts.

Of course, for the above described and following embodiments, the foreground and background segmentation and replacement may be interchanged, to facilitate background and/or foreground segmentation and replacement.

According to some embodiments, the Segmentation engine input artifacts includes Input artifacts types such as Common video files that include audio in them; Video files without audio; Images; Audio files etc. The segmentation engine artifacts described above can be of substantially any format/codec/size/shape according to the relevant artifact type.

The input artifacts can come in various combinations according to the requested output artifact. Parts of the artifacts may be used as the output artifact foreground, and parts may be used as the output artifact background. Artifacts that may be used as foreground of the output artifact may include video files, audio files (separated from video or not) and/or images. Artifacts that may be used as background of the output artifact may include video files, audio files (separated from video or not) and/or images.

Accordingly, substantially any content may be processed by the segmentation engine, including Video files, image files and audio files, whether filmed using a standard colored or natural backdrop, or a specialized “green/blue screen studio”. In general, following a defined list of filming/shooting/recording guidelines may improve the output artifact. More specifically, videos/images may not be required to be filmed or shot in front of a green/blue screen in order to get quality output artifacts. Nevertheless, green/blue background videos/images may also be handled by the segmentation engine. Moreover, the input file content may not have to include a human image in it or be limited to a single person image. Substantially, any filmed content may be a valid input artifact for the segmentation engine, for example, to be processed and run on a multimedia viewing platform, such as a website, television broadcast, gaming session, video conference etc.

According to some embodiments, the Segmentation engine output artifacts may include various types of video, audio and/or image artifacts. The output artifact files may be comprised of a variety of formats/codecs/sizes/shapes, as described above in relation to the input artifact types.

In a first example of a common output artifact type, the video file may include foreground and audio data from the input video (or from a separated audio file) and a transparent background (alpha channel) replacing the original input video background. In a second example, the video file may include foreground and audio from the input video (or from a separated audio file) and a background input image replacing the original input video background. In a third example, the video file may include foreground and audio from the input video (or from a separated audio file) and a background additional input video replacing the original input video background.

In a further example of a common output artifact type, the image file may include foreground from the input image and a background input image replacing the original input image background. In some cases, image files may hold foreground data from the input images and a background input image replacing the original input images background. These images can also be frames that can be integrated into a video.

In some embodiments, these outputs may also rely on multiple input videos/images/audios such that one output artifact can hold a number of foreground videos/images on top of a background video/image.

In an additional example of a common output artifact type, the audio file may include audio that is an integral part of a video, a separated supplied audio file, a real time recording as part of a call/video call or any recording device, a music file or audio effects that can be inserted into the output artifact.

According to some embodiments, the Segmentation engine runs code based on logic and specifications, to enable effective data segmentation and replacement. The segmentation engine, for example, applies a set of predefined algorithms based on predefined thresholds and flags. In some embodiments, a high-level flow of the engine logic may include, for example: receiving and validating input artifacts, pre-processing artifacts, adjusting output and working size/resolution/length etc., creating background models, finding empty frames and/or empty frame parts in which only the background is visible, building a background model using the information in two color spaces: RGB (Red, Green, Blue) and HSV (Hue, Saturation, Value), detecting artificial blank lines (rows or columns) that may originate from the recording device and incorporating them into the background model.

Further algorithms may be implemented to enhance the main processing process, for example, by performing segmentation per frame (loop), executing frame illumination and color correction using data from the background model, calculating a foreground image by comparing the background model and the current illumination/color corrected frame in RGB and HSV color spaces, and optionally compare current frame to other frames in the video to better define which pixels can most likely be considered as foreground/background (temporal filtering).

Additional algorithms may be implemented to enhance the post processing, for example, by fine tuning the main process results using color and brightness information, gradient maps, edges extracted from a Canny edges detector, replace detected background pixels with the background input artifact (video frame, image, transparent/alpha channel value etc.), write segmented image data into output artifact (video/image), processing more input artifacts if they exist, based on expected output artifact format/codec/size/resolution/audio, create the output artifact.

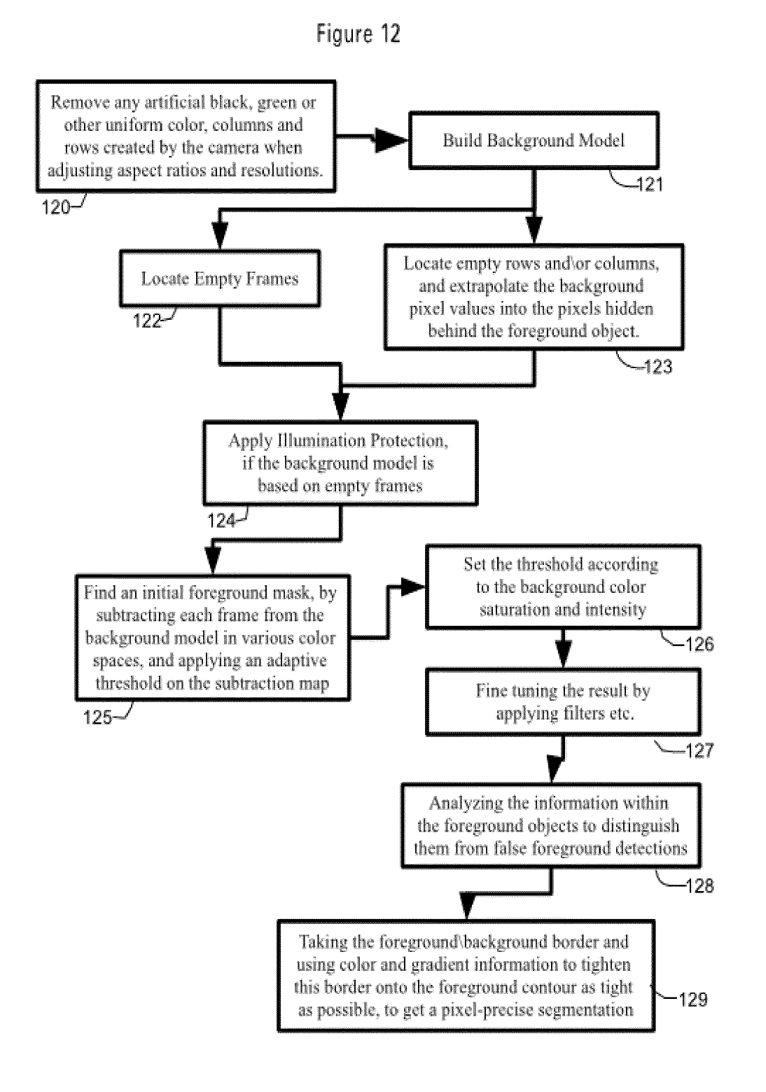

According to some embodiments, as can be seen with reference to FIG. 12, the following guidelines of a processing algorithm or set of steps may be used. Of course, other steps or combinations of steps may also be used. At step 120, the engine may remove any artificial black, green or other uniform color, columns and rows created by the camera when adjusting aspect ratios and resolutions. At step 121 the background model may be build, using two alternative methods. At step 122 empty frames may be located (i.e. frames without foreground objects). At step 123 empty rows and/or columns may be located, and the background pixel values may be extrapolated from these pixels into the pixels hidden behind the foreground object. At step 124 illumination correction may be applied, if the background model is based on empty frames (since objects entering the scene can cause changes in the background pixels values). At step 125 an initial foreground mask may be found, by subtracting each frame from the background model in various color spaces and applying an adaptive threshold on the subtraction map. The threshold may be set according to the background color saturation and intensity. At step 126 the result may be fine tuned, for example, by applying morphological filters for filtering out outliers, noise etc. at step 127, analyzing the information (mainly gradient and edges information) within the foreground objects to distinguish them from false foreground detections, at step 128, and/or taking the foreground\background border and using color and gradient information to tighten this border onto the foreground contour as tight as possible, in order to get a pixel-precise segmentation.

Although the above detailed list of engine flow steps describe a typical flow of the segmentation engine, any combination of these steps or any partial flow or additional steps it may executed in order to generate the listed output artifacts.

The segmentation engine's logic and specifications may be designed to enable automated segmentation, such that the user does not need to specify which parts of the input artifact is considered foreground or which is the background. Further, automated segmentation can be implemented with input artifacts relating to backgrounds of substantially any color. Additionally, segmentation logic does not rely on face recognition or any predefined limitations about the shape/size/type of the objects in the video/image. For example, the foreground to be used after the background is removed may be one or more people, animals or substantially any object(s) which fit into the pre-determined specifications for achieving better results are kept. Further, objects can go in and out of the frame as the user sees fit. Moreover, the segmentation logic and specifications may be designed to provide automated results rapidly, such as within seconds or minutes, depending on the input artifact's size, length and content.

As described, one of the optional steps in the engine's work flow is based on comparing each input frame to a background reference frame. The engine collects or creates a set of possible reference frames that try to best represent the assumed possible background. Once the best reference background frame to work with based on defined parameters and sensitivity levels, the engine compares the reference frame to the input image in order to better define which pixel in the image should be the foreground and which the background.

The following or other examples of the ways the engine finds or created reference frames may be used: Look for empty images without any object in them and assume they are a background image; Look for sets of pixels with similar colors (based on sensitivity thresholds) like rows/columns or other shapes and assume they belong to the background; Complete the rest of the reference frame with similar colors to that set of pixels to a point that a full reference frame is created. In general, the segmentation engine may perform substantially the same reference frame creation logic as the previous one, but collect data from several input frames in order to build a more accurate reference frame. One of the advantages of creating a reference frame per image according to sets of equal colored pixels comes from the fact that background images in videos/images are usually not homogeneous, due to lighting differences and camera behaviors. Using such methods create reference frames that are closer to the actual background frame and provide better outputs.

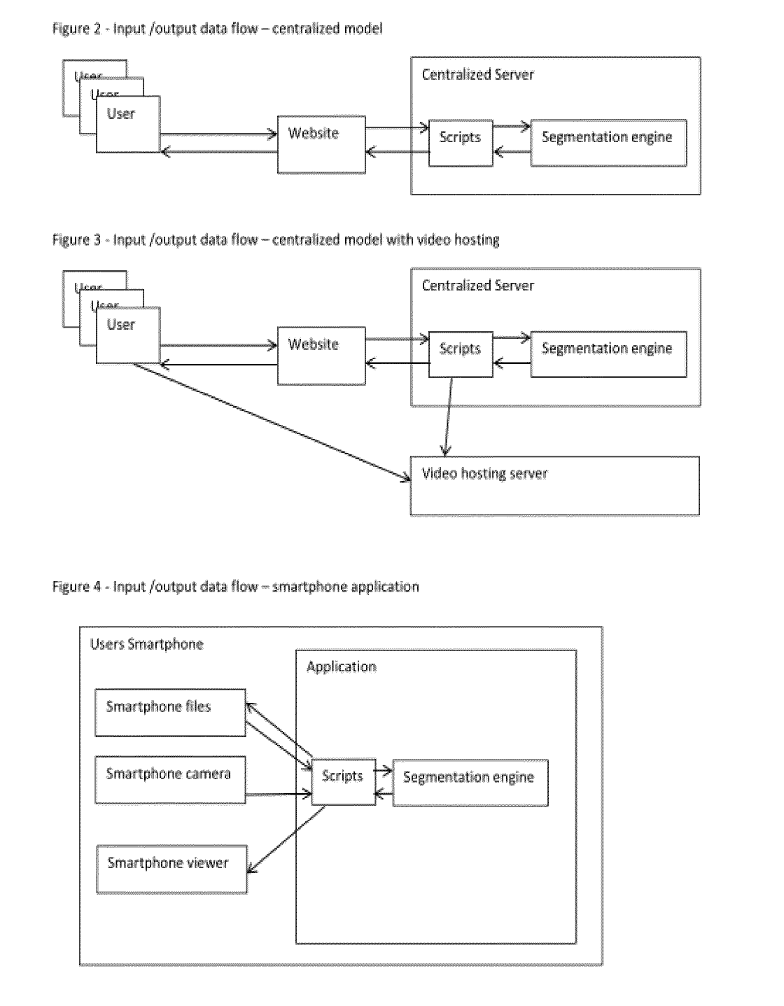

According to some embodiments, a system is provided that includes software that runs the segmentation engine and utility scripts designed to handle the input and output artifacts, including the user interface(s). The software may be located and executed on any operating system and in different models. See FIGS. 2-9 for implementation examples. For example, the segmentation engine and utility scripts may be run on a central server and can be accessed via a centralized website in a way that users can upload input artifacts into the software and collect the output artifacts once the segmentation process has been completed.

In another example, the segmentation engine and utility scripts may be downloaded or installed on a customer's servers or PCs so that they can use it locally on their servers/PCS for segmenting their input artifacts.

In a further example, the segmentation engine and utility scripts or parts of it may be integrated as an additional module into an existing software or existing platform, such that the other platforms/software could offer the system abilities as part of their software/platforms services.

In an additional example, the segmentation engine and utility scripts or parts of it may be run on a smartphone while integrating with any smartphone application that relies on its abilities. Running as part of a smartphone application can be done by either running most or all of the software on the smartphone or just running parts of the software that interact with the rest of the software that will be running on a centralized server.

According to some embodiments, the software based scripts or code may be designed to support the segmentation engine in order to complete its end to end functionality. Examples of Website functionality enabled by such additional scripts may include: Arranging input artifacts and preparing them for the segmentation engine execution; Interacting with users (e.g., sending emails, verifying uploaded file types/size/length etc.); Extracting and planting audio files from the input artifacts and into the output artifacts; Improving output audio by reducing background noises; Converting segmentation engine output artifacts into an expected format (e.g., SWF, mov, png etc) and length; Applying compression logic(s) on the output artifacts or even reducing its size by dumping some of the frames in a video file; Generating the needed HTML/XML code, instructions, needed scripts and video/flash/image players to fit to the relevant expected output artifact and its expected usage; Allowing the user to test the output artifacts and to adjust their basic appearance parameters such as size, location, shapes and more; Allowing users to choose an existing background input artifact from a predefined list of templates (videos/images); Allowing users to embed their output artifacts on top of their website on the internet, by generating the needed integration code that when used will get the output artifact to run on top of the users website pages; Allowing users to run their output artifacts on top of any website on the internet, by generating an internet link (URL) and needed HTML embedding code that when used will seem as if the video is actually running on that website, and more.

According to some embodiments, the software based scripts may be designed to support the segmentation engine in order to complete its end to end functionality in a variety of multimedia viewing platforms, including non-web contexts. Examples of implementation include television broadcasts, game execution, streaming media etc., wherein the scripts are adapted to enable background replacement may be run, to enable automated video background replacement, as described above.

In one example, a software script may be used to manage a list of actors that are willing to make an input artifact, so that users may use their services for creating the input artifacts and interact with the actors via the system software. In another example, the output artifact may be copied into a 3^{rd} party server or onto a separated device. In a further example, the outputs identity/ids may be managed to allow the user to embed his/her output artifact id into a module/plug-in so that it will automatically located and displayed in the artifact. In another example, a plug-in, smart-phone application or module may be used that interacts with the segmentation engine. According to some embodiments, the output artifacts may be presented to users on demand or substantially in real time.

According to some embodiments, the Output artifacts may be used to enhance the process of replacing a video/image background. Accordingly, many usages of the segmentation engine's output artifacts can be automatically applied by users, including, for example, the following applications: Running a video with transparent or replaced background on top of websites as a virtual spokesperson, a virtual trainer, multi languages presenters, support/troubleshooting guides, reoccurring message of the day/week to the viewers, display of products, deals promotions, companies internal websites announcements to employees, games, interactive clips that can interact with the website's elements (e.g., images, buttons) and can interact with the viewers actions (e.g., typed words, clicks on element) etc. In other examples, a personal video with a transparent/replaced background may be added on top of the user's profile or personal page on any social/blog-like/business platform. In another example, a video with transparent or replaced background may be run on top of websites that are not owned by the video owner. For example, by using a generated internet link that redirects the data from other sites (could be famous websites), one could appear as if s/he is displayed on top of other websites. Such usage can be done for purposes of online greetings, personal messages to specific viewers on top of selected webpages, practical jokes, advertising, website guides on top of other websites, wedding invitations, games and more.

In still further examples, template video/images may be used that will appear on the user's video background as part of a smartphone, tablet or computer application, for creating a funny/interesting clip, games, greetings, music clips, lectures, or any type of video/image. In other examples, after user uploads a video onto a video managing platform, s/he will have the option to automatically remove his/her video background and replace it with another video/image/template of images/videos. This could be achieved for example by a click of a button by the user. In still further examples, a video could be presented with a transparent or replaced background “on the fly” (substantially in real time), meaning that the output artifact could be presented substantially at the same time (with a minimal delay for processing time) that it is recorded. For example, users in an online video call/conference could choose to replace their presented background with an image or another video(s) so that the user on the other side of the call will see them in real time on the video call with a replaced/transparent background. The above described implementations can be relevant to a variety of video/image related multimedia viewing platforms or channels such as the PCs, television (TV), smartphones, tablets, multimedia players, game consoles and more.

In an additional example, a personal user may make a video clip in which s/he uses a solid colored wall as background and appears saying a few sentences such as “welcome to my website”. The user may use his/her video as input to the invented segmentation engine, and get an output SWF (flash) video file in which the white wall background has been replaced with a transparent background (i.e. alpha channel). The user may put the output video file on a page of his/her website so that every visitor in the website will see his/her clip as “floating” on top of the webpage, leaving the video background transparent, which gives it a see-through effect.

In another embodiment, a personal user may make a video clip in which s/he uses a white wall as background and appears saying a few sentences such as “welcome to the jungle”. The user uses his/her video as input to the segmentation engine with the addition of an input of a jungle image and gets an output MOV video file in which the solid colored wall background has been replaced by the jungle image as background. The user puts this/her output video file on the front page of his/her website so that every visitor in the website will see his/her video clip that will appear as if it was taken in a real jungle.

In a further embodiment, a 3^{rd} party software platform may add an invention plugin/module to its software, thereby allowing users to click on a button in order to segment a video they own as input into a video/images output that will have a replaced or transparent background.

In another embodiment, a user uses his/her smartphone to make a video, which s/he can automatically segment using a smartphone application running on his/her device, thereby providing the user with a video/image with a replaced or transparent background.

In a further embodiment, two or more people may make a video call from their mobile phones or computers, such that each user sees the other with a replaced or transparent background that may be replaced substantially in real time by the system.

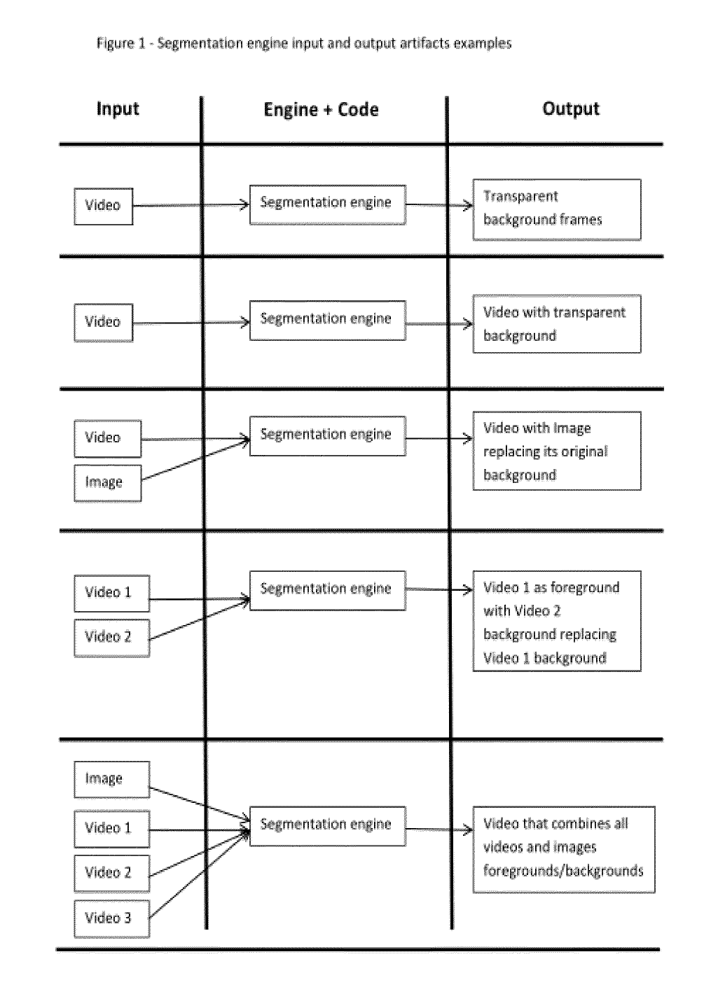

Reference is now made to FIG. 1, which is a flow chart illustrating examples of input and output examples by a Segmentation engine with associated code, according to some embodiments.

FIG. 2 is a flow chart illustrating examples of input and output flow by a Segmentation engine using a centralized model, according to some embodiments.

FIG. 3 is a flow chart illustrating examples of input and output flow by a Segmentation engine using a centralized model with video hosting, according to some embodiments.

FIG. 4 is a flow chart illustrating examples of input and output flow by a Segmentation engine using a smartphone application, according to some embodiments.

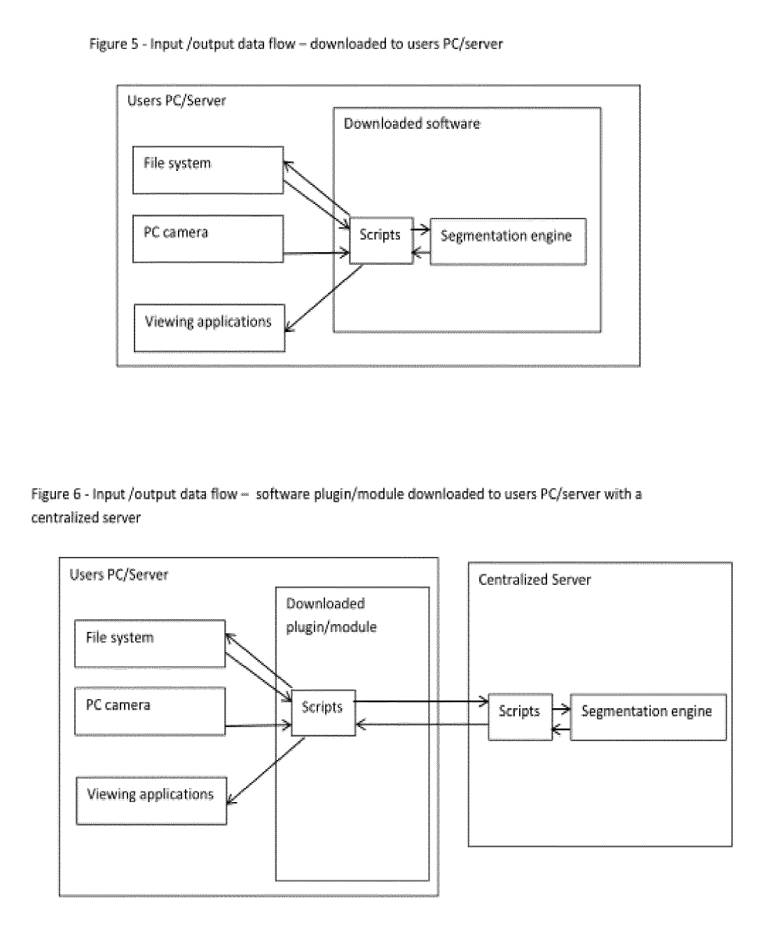

FIG. 5 is a flow chart illustrating examples of input and output flow by a Segmentation engine using software downloaded to users PC/server, according to some embodiments.

FIG. 6 is a flow chart illustrating examples of input and output flow by a Segmentation engine using a software plugin/module downloaded to users PC/server with a centralized server, according to some embodiments.

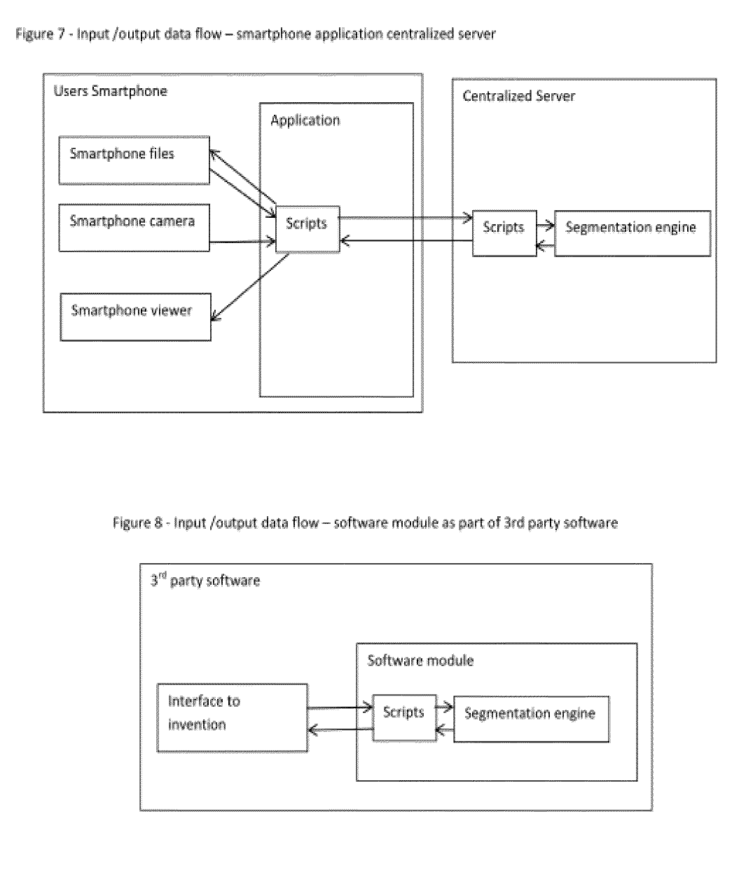

FIG. 7 is a flow chart illustrating examples of input and output flow by a Segmentation engine using a smartphone application and a centralized server, according to some embodiments.

FIG. 8 is a flow chart illustrating examples of input and output flow by a Segmentation engine using an interface module connected to a centralized server as part of 3rd party software, according to some embodiments.

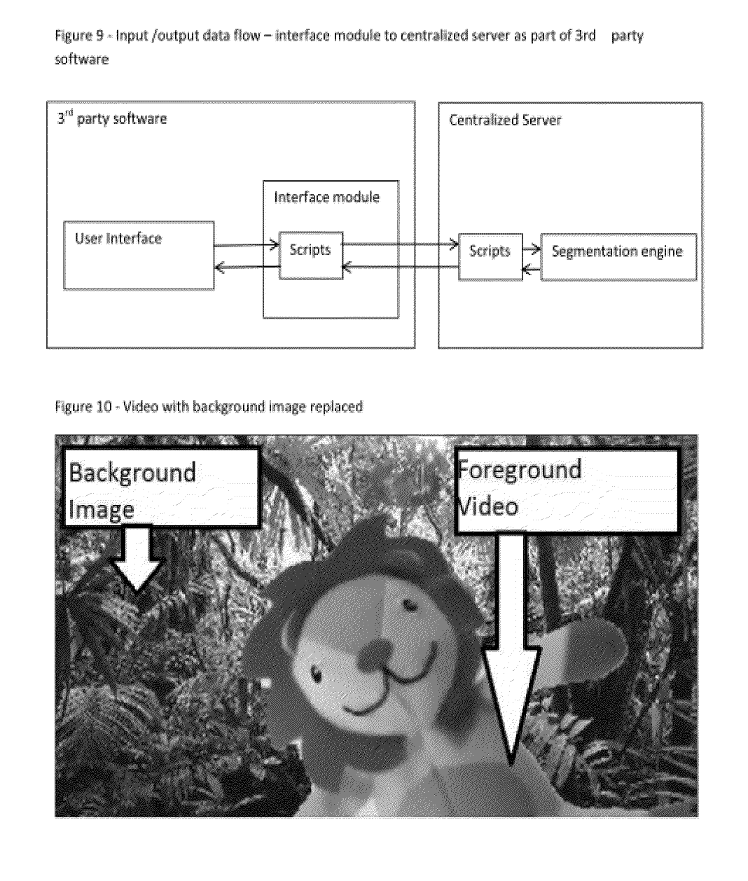

FIG. 9 is a flow chart illustrating examples of input and output flow by a Segmentation engine using a software module as part of 3rd party software, according to some embodiments.

FIG. 10 is an example of a screenshot showing a Video clip with its background image replaced, according to some embodiments.

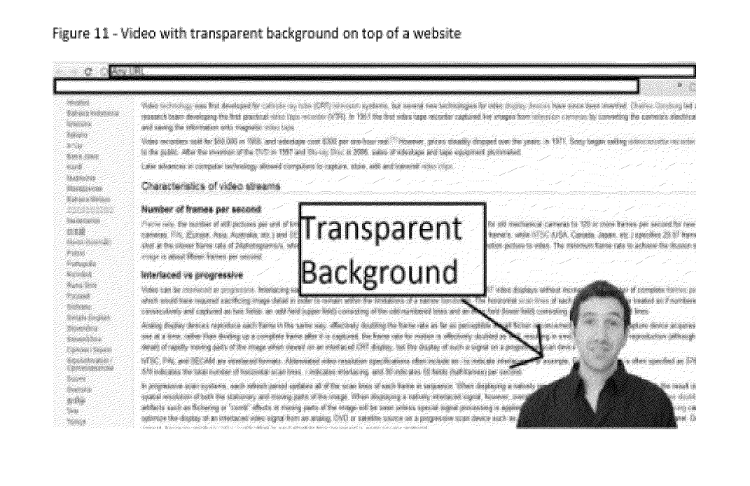

FIG. 11 is an example of a screenshot showing a Video clip with a transparent background on top of a website, according to some embodiments.

In view of the above descriptions, video and or image frames/files from substantially any 2D camera may be automatically segregated and replaced processed, whatever the quality, resolution, aspect ratio and compression format. Further, images or clips from cameras with automatic gain control may be processed, even when auto white balance and color correction are enabled, which are mechanisms that may cause major changes in the frame. Moreover, static or dynamic cameras may be used, and there are no substantial limitations regarding the number and nature of the objects in the scene.

In further embodiments, the captured background (BK) may be processed even when appearing substantially uniform to the human eye, yet not being substantially uniform for a computer processor. For example, the system may handle background colors that seem uniform to the human eye, such as in cases in which the eye will consider the background to be uniformed, while a computer will “see” many un-uniformed colors. Therefore the BG does not need to have an exact constant color value, and the BG may be constructed from substantially any colors, thereby freeing the user to capture a scene film against standard backgrounds or an “amateur standard environment”, for example at home or at the office, and not needing to use “a professional studio standard filming environment” in which the video's BG color is more unified.

Furthermore, automated segmentation and/or replacement may not require substantially any user input, such as reference image, color key or seeds (e.g., marking of BG and foreground (FG) pixels). In still further examples, the system may process substantially any frames, whether with content or empty, for the purposes of BG learning. For example, a frame may be processed even where the FG takes up most of the field of view.

Human complexion is usually bright and similar to the most common background—a white wall. This combined with lighting that can cause saturation on faces, resulting in background “holes” in the faces. To tackle this problem, according to further embodiments, face detection processing may be applied to shield these areas from the phenomena mentioned above.

Typically, videos of a person in front of a wall or feature will include all or most of a person's body on top of the wall, the floor and the line separating it from the wall. This problem may be handled, according to further embodiments, by detecting the borderline between the person or primary object, and the background lines, by using a modified real-time Hough transform that is optimized to finding horizontal or near-horizontal lines. After the line is found, background models may be learned, for example, for the wall and the floor.

According to further embodiments, motion information may be used for finding depth in the image, to help the segmentation task.

According to further embodiments, a condensation algorithm may be used for tracking the foreground\background border throughout a movie sequence, to improve the accuracy of the segmentation.

In accordance with some embodiments of the present invention, an application is provided for enabling video background replacement, including a segmentation and replacement engine and engine output processing scripts; a video hosting module; and a user operating an end user device with a multimedia viewing capability on which a video frame with a replacement video background is to be run.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for enabling video foreground and/or background replacement, comprising:
a video segmentation and replacement module including a segmentation and replacement engine and engine processing script(s);
a program interface for allowing data provision to said segmentation and replacement module; and
an end user device providing remote user access to said server, wherein said remote device runs code to enable automatic placement of a selected frame foreground with a selected frame background, for viewing on said device.

2. The system of claim 1, wherein said code is a video segmentation and replacement application.

3. The system of claim 1, wherein said segmentation and replacement module runs on a server.

4. The system of claim 1, wherein said segmentation and replacement module runs on a data cloud.

5. The system of claim 1, wherein said segmentation and replacement module runs on a remote user device.

6. The system of claim 1, wherein said selected frame foreground is configured with a selected replacement frame background.

7. The system of claim 1, wherein said selected frame background is configured with a selected replacement frame foreground.

8. The system of claim 1, wherein said background is a transparent background.

9. The system of claim 1, wherein said segmentation engine and segmentation script are adapted to enable background segmentation of a frame captured against a standard backdrop.

10. The system of claim 8, wherein said frame is one of a stills image, video frame and animation frame.

11. The system of claim 1, wherein said multimedia end user device includes one or more devices selected from websites, PCs, televisions, smartphones, tablets, multimedia players, communication devices and game consoles.

12. A method for enabling remote user video background replacement, comprising:
running video segmentation code to automatically segregate a video frame background and foreground;
allowing a remote user to choose an existing background input artifact from a predefined list of templates; and
running video background replacement code to allow said user to run a selected multimedia output artifact on top of a multimedia viewing application, with said selected background input artifact, by generating an integration code that causes said output artifact to appear on top of said multimedia program.

13. The method of claim 12, further comprising allowing said user to run said multimedia output artifacts on top of a multimedia program, by generating a link and embedding code to cause the selected multimedia output artifacts to actually run on a selected multimedia program.

14. The method of claim 12, wherein said video segmentation code acts to segregate a video frame background and foreground by:
comparing each video input frame to a background reference frame, by a segmentation engine;
collecting a set of possible reference frames, by said segmentation engine that represent the assumed possible background;
selecting an optimal reference background frame to work with based on defined parameters and sensitivity levels;
comparing said reference frame to said input frame in order to better define which pixel in the frame should be the foreground and which pixel should be the background.

15. The method of claim 12, wherein said existing background input artifact is acquired from a video filmed with a standard colored backdrop.

16. A platform for enable video foreground and/or background replacement, comprising:
a centralized server running a segmentation engine and video replacement scripts;
a video hosting source;
a multimedia viewing platform on which a video frame with a replacement video background and/or foreground is to be run; and
a user operating an end user device;
wherein said replacement scripts are designed to segment and configure a remote user video background and/or foreground on a selected multimedia viewing platform.

17. The platform of claim 16, where said background and said foreground may be interchanged.

18. The platform of claim 16, where said platform may include one or more platforms selected from websites, PCs, televisions, smartphones, tablets, multimedia players, and game consoles.

19. The platform of claim 16, further comprising an application for enabling video background replacement on an end user device, the application including engine output processing scripts to provide enhancing foreground and/or background processing to enable selected video frame foreground(s) with selected video frame background(s) to be run on the end user device.
